(19) United States
(12) Patent Application Publication
(10) Pub. No.: US 2026/0270797 A1
(43) Pub. Date: Sep. 10, 2026

(54) Traffic Identifier (TID) to Link (TID-TO-LINK) Mapping to Avoid Upcoming Breach of a Service-Level Agreement

(71) Applicant: QUALCOMM Incorporated, San Diego, CA (US)

(72) Inventors: Shashikala Baila Prabhu, Mangalore (IN); Gyanranjan Hazarika, Milpitas, CA (US); Ganesh Mani, Chennai (IN); Sandip HOMCHAUDHURI, San Jose, CA (US); Viren Umrigar, Dublin, CA (US); Krishna Chaitanya Rao, Bangalore (IN); Venkateswara Swamy Bandaru, Bangalore (IN)

(21) Appl. No.: 19/497,724

(22) PCT Filed: Sep. 25, 2023
(86) PCT No.: PCT/US2023/075038

§ 371 Date: Dec. 29, 2025

(30) Foreign Application Priority Data
Jun. 28, 2023 (IN) 202321043341

(51) Int. Cl. H04W 28/24; H04W 76/15

(52) U.S. Cl. CPC H04W 28/24; H04W 76/15

(57) ABSTRACT

This disclosure provides methods, components, devices, and systems for employing a traffic identifier (TID) to link (TID-to-link) mapping scheme to proactively avoid possible upcoming breaches of a service-level agreement (SLA) associated with a device (an “SLA-aware device”). The SLA may impose certain low latency or throughput requirements. An unavailability of a first link on which the SLA-aware device is operating may cause the SLA to be breached. Breach of the SLA may result in disruptions to the operation of the SLA-aware device and subject the party associated with the breach of the SLA to penalties. In aspects, an event associated with an upcoming breach of the SLA is identified and a TID-to-link mapping scheme associated with unavailability information is transmitted. The unavailability information indicates an unavailability associated with the first link, and the TID-to-link mapping scheme maps at least one TID to a second link other than the first link.

### TECHNICAL FIELD

This disclosure relates generally to wireless communication, and more specifically, to employing traffic identifier (TID) to link (TID-to-link) mapping to avoid an upcoming breach of a service-level agreement associated with a multi-link device.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

An STA may have a service-level agreement (SLA) associated with the STA. The SLA may impose certain functionality or performance requirements on the associated STA. A disruption in the network, e.g., an interruption in the link on which the STA associated with the SLA is operating, may cause the SLA to be breached.

### SUMMARY

The systems, methods and devices of this disclosure each have several innovative aspects, no single one of which is solely responsible for the desirable attributes disclosed herein.

In some examples, a method for wireless communication performable at a wireless access point (AP) multi-link device (MLD) includes communicating traffic over a first link. The method includes identifying an event associated with an upcoming service-level agreement (SLA) breach for an SLA-aware device operating on the first link. The method includes transmitting a traffic identifier (TID) to link (TID-to-link) mapping scheme in association with unavailability information based at least in part on the event associated with the upcoming SLA breach. The unavailability information indicates an unavailability associated with the first link, and the TID-to-link mapping scheme is configured to map at least one TID to a second link other than the first link.

In some examples, the unavailability information indicates an unavailability start time and an unavailability duration.

In some examples, the TID-to-link mapping scheme is configured to map all TIDs to the second link.

In some examples, the TID-to-link mapping scheme is configured to map a subset of all TIDs to the second link.

In some examples, an access point (AP) includes at least one memory and at least one processor communicatively coupled with the at least one memory. The processor is operable to cause the AP to communicate traffic over a first link and identify an event associated with an upcoming service-level agreement (SLA) breach for an SLA-aware device operating on the first link. The processor is operable to cause the AP to transmit a traffic identifier (TID) to link (TID-to-link) mapping scheme in association with unavailability information based at least in part on the event associated with the upcoming SLA breach. The unavailability information indicates an unavailability associated with the first link, and the TID-to-link mapping scheme is configured to map at least one TID to a second link other than the first link.

In some examples, a method for wireless communication performable at a wireless access point (AP) multi-link device (MLD) includes transmitting a first traffic identifier (TID) to link (TID-to-link) mapping scheme to map at least one TID to the first link and communicating traffic over the first link. The method includes identifying an event associated with an upcoming service-level agreement (SLA) breach for an SLA-aware device operating on the first link. The method includes transmitting a second traffic identifier (TID) to link (TID-to-link) mapping scheme in association with unavailability information based at least in part on the event associated with the upcoming SLA breach. The unavailability information indicates an unavailability associated with the first link, and the TID-to-link mapping scheme is configured to map at least one TID to a second link other than the first link.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example traffic identifier (TID) to link (TID-to-link) mapping information element.

FIG. 3 shows a sequence diagram depicting networking communications between an access point (AP) multi-link device (MLD) and a non-AP MLD.

FIG. 4 shows a sequence diagram depicting example networking communications between an AP MLD and a non-AP MLD, according to some aspects.

FIG. 5 shows an example Channel Switch Announcement (CSA) information element.

FIG. 6 shows a sequence diagram depicting networking communications between an AP MLD and a non-AP MLD being disrupted due to radar detection.

FIG. 7 shows a sequence diagram depicting example networking communications between an AP MLD and a non-AP MLD, according to some aspects.

FIGS. 8A through 8G show example TID-to-link information elements usable to take proactive corrective action in the event a radar is detected on a link, according to some aspects.

FIG. 9 shows a sequence diagram depicting example networking communications between an AP MLD and a non-AP MLD, according to some aspects.

FIG. 10 shows a schematic illustrating example off-channel scanning.

FIG. 11 shows a schematic illustrating the use of TID-to-link mapping in association with off-channel scanning, according to some aspects.

FIG. 12 shows a flowchart illustrating an example process performable by an AP MLD that supports TID-to-link mapping, according to some aspects.

FIG. 13 shows a block diagram of an example wireless communication device that supports TID-to-link mapping, according to some aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to employing a traffic identifier (TID) to link (TID-to-link) mapping scheme to proactively avoid possible upcoming breaches of a service-level agreement (SLA) associated with a device (an “SLA-aware device”). The SLA may impose certain low latency or throughput requirements. An unavailability of a first link on which the SLA-aware device is operating may cause the SLA to be breached. Breach of the SLA may disrupt operation of the SLA-aware device, decrease productivity, and subject a party associated with the breach of the SLA to penalties. In some aspects, an event associated with an upcoming breach of the SLA is identified and a TID-to-link mapping scheme associated with unavailability information is transmitted. The unavailability information indicates an unavailability associated with the first link, and the TID-to-link mapping scheme maps at least one TID to a second link other than the first link.

The event may be any event associated with the upcoming unavailability of the first link. The event may, for example, be associated with detecting radar on the first link. The event may be associated with off-channel activity. The event may be associated with an Automatic Channel Selection (ACS) scan, advertisement of a Quiet information element, or another event.

Particular aspects of the subject matter described in this disclosure can be implemented to realize one or more of the following potential advantages. In some examples, transmitting a TID-to-link mapping scheme in association with unavailability information based at least in part on the event associated with the upcoming SLA breach causes traffic to be routed to a second link, thereby avoiding a breach of the SLA. Disruptions in the operation of the SLA-aware device and penalties associated with breach of the SLA may therefore be avoided.

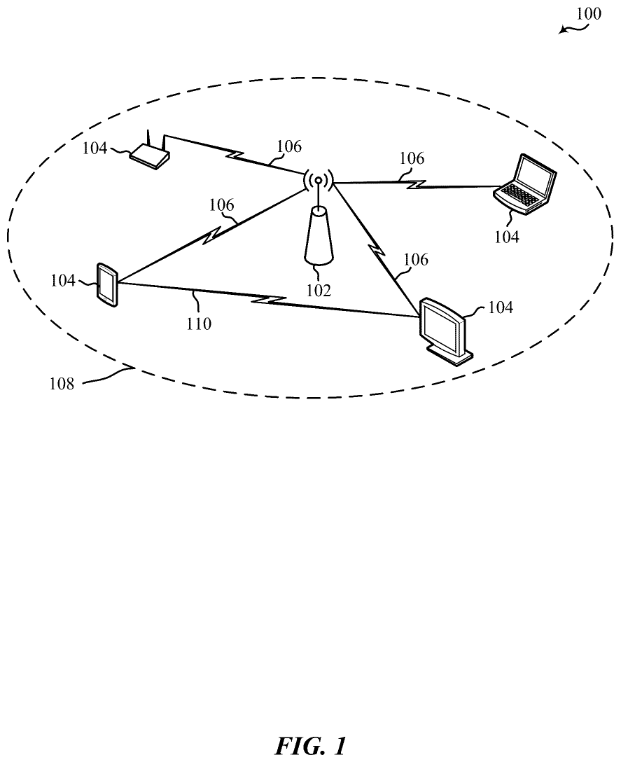

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IOT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (us)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time. One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

One or more STAs, such as one or more of the STAs 104, may have a service-level agreement (SLA) associated therewith. The SLA may govern the relationship between an owner or user of the SLA-aware STA 104 and a service provider. The SLA may impose certain requirements on the operation of the STA 104. For example, the SLA may require that the STA 104 meet certain low latency or throughput criteria. Disruptions in the operation of the SLA-aware STA 104, due e.g., to interruption of a link on which the SLA-aware STA 104 is operating, may cause the associated SLA to be breached.

In implementations, the AP 102 and the SLA-aware STA 104 are capable of multi-link operation. That is, the AP 102 and the SLA-aware STA 104 may be capable of communicating with each other simultaneously over two or more links (e.g., two or more of a 2.4 GHz link, a 5 GHz link, and a 6 GHz link). In cases in which an STA 104 has an SLA associated therewith, it may be preferable for the AP 102 to communicate with that STA 104 over a single link, notwithstanding the availability of multiple links. Allowing each SLA-aware device, such as each SLA-aware STA 104, to communicate with the AP 102 over the multiple available links may increase the entropy of the network 100 and make the communications indeterministic. Such may increase the likelihood of breaching an SLA associated with an STA. Therefore, an AP MLD, such as the AP 102, may map traffic identifiers (TIDs) associated with a particular SLA-aware device, such as an SLA-aware STA 104, to a particular link. For example, the AP MLD may map all the TIDs associated with a particular SLA-aware device to a particular link based on a quality-of-service (QOS) management algorithm, a load-balancing algorithm, or an application associated with the STA MLD.

A traffic identifier or TID may classify a packet in the network 100, e.g., indicate that the packet carries audio data, video data, or other type of data. An AP MLD may map all the TIDs associated with an SLA-aware device to a particular link using a TID-to-link mapping mechanism. As set forth in the 802.11 family of standards, e.g., the standards associated with 802.11be (or subsequent generations), a TID-to-link mapping mechanism allows an AP MLD and a non-AP MLD that performed or are performing multi-link setup to determine how data frames (e.g., data frames belonging to TIDs 0-7) and management frames will be assigned for transmission on the setup links between the two MLDs in downlink and uplink. By default, all TIDs may be mapped to all setup links for both downlink and uplink.

An AP MLD, such as the AP MLD 102 that supports TID-to-link mapping functionality, may initiate TID-to-link mapping negotiation in one of two ways. The AP MLD may advertise the TID-to-link mapping in a beacon or probe response frame, which may globally map all TIDs to a particular link or link set for both downlink and uplink (herein, global TID-to-link mapping). Or the AP MLD may send an individually addressed TID-to-link mapping request frame to a non-AP MLD (herein, peer-to-peer TID-to-link mapping), such as to a particular STA MLD 104. The peer-to-peer TID-to-link mapping may be torn down by either peer using a TID-to-link mapping Teardown frame. The peer-to-peer TID-to-link mapping may also be discarded if it was established prior to the establishment of a global TID-to-link mapping advertised by the AP in a beacon or probe response frame. Currently, the standards associated with 802.11be provide that an AP advertising a TID-to-link mapping in a beacon or probe response frame will map all TIDs to the same link or link set for both uplink and downlink, although it is also envisioned that an AP functioning in accordance with subsequent generations or revisions to the 802.11be standards may map different TIDs to different links or link sets.

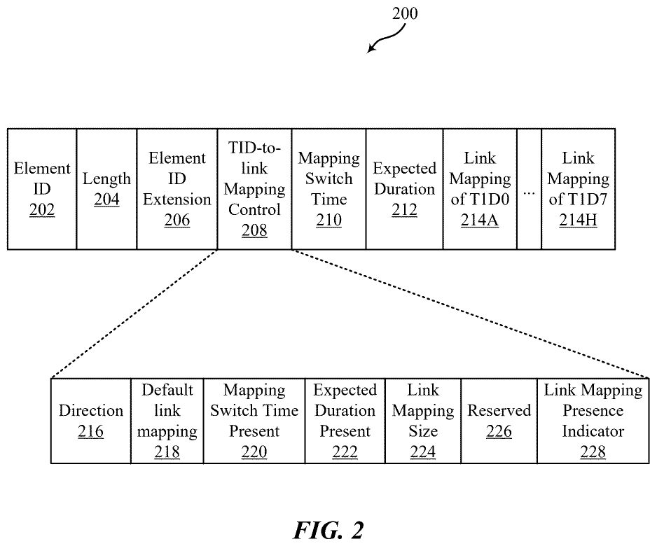

FIG. 2 shows an example TID-to-link mapping IE 200 usable to map TIDs to a link. The format of the TID-to-link mapping IE 200 may conform to an IEEE 802.11 standard, such as that defined by the IEEE 802.11-2016 specification or amendments thereof including, but not limited to, 802.11ah, 802.11ad, 802.11ay, 802.11ax, 802.11az, 802.11ba, and 802.11be. The TID-to-link IE 200 may be broadcast by an AP MLD to the STAs in communication with the AP MLD. For ease of explanation, some information elements of the TID-to-link mapping IE 200 may also be referred to as a “field,” a “subfield,” an “element,” or a “subelement,” which may be considered interchangeable terms for purposes of discussion herein.

The TID-to-link mapping IE 200 may include an Element ID field 202, a Length field 204, an Element ID Extension field 206, a TID-to-link Mapping Control field 208, a Mapping Switch Time field 210, an Expected Duration field 212, and Link Mapping fields for TIDO (field 214A) through TID7 (field 214H).

The Element ID field 202 may have a fixed value of 255. The Length field 204 may indicate the length of the TID-to-link mapping IE 200. The Element ID Extension field 206 may have a fixed value of 109 indicating that the current IE 200 is a TID-to-link mapping IE. The Mapping Switch Time field 210 may indicate the time at which the advertised TID-to-link mapping is to take effect. The unit of the Mapping Switch Time field 210 may be the timing synchronization function (TSF). The Expected Duration field 212 may indicate the duration for which the advertised mapping is valid. The unit of the Expected Duration field 212 may be time units (TUs). After the expiration of the Expected Duration, unless another TID-to-link mapping takes effect, the AP MLD may revert to default mapping where all TIDs are mapped to all available links.

The Link Mapping of TID n fields 214A-214H (where n=0, 1, . . . , 7) indicate the link(s) on which frames belonging to TID n are allowed to be sent (i.e., carries a bitmap of the links to which the TID n is mapped to). A value of 1 in bit position i (where i=0, 1, 2, . . . , 14) of the Link Mapping of TID n field indicates that TID n is mapped to the link associated with the link ID i. A value of 0 in bit position i indicates that the TID n is not mapped to the link associated with the link ID i.

The TID-to-link Mapping Control field 208 may include seven subfields: a Direction subfield 216, a Default link mapping subfield 218, a Mapping Switch Time Present subfield 220, an Expected Duration present subfield 222, a Link Mapping Size subfield 224, a Reserved subfield 226, and a Link Mapping Presence Indicator subfield 228.

The Direction subfield 216 may indicate the direction for which the TID-to-link mapping is applicable. A value of zero of the subfield 216 may indicate a downlink direction, a value of one of the subfield 216 may indicate an uplink direction, and a value of two of the subfield 216 may indicate bidirectional mapping. The Default link mapping subfield 218 may indicate whether the current mapping is default mapping. Specifically, a value of one of the default link mapping subfield 218 may indicate that all TIDs are mapped to all links. A value of zero of the default link mapping subfield 218, conversely, may indicate that the TID-to-link mapping IE 200 includes the link mapping information. The Mapping Switch Time Present subfield 220 may be set to one where the TID-to-link mapping IE 200 includes a Mapping Switch Time in field 210, and may otherwise be set to zero. The Expected Duration present subfield 222 may be set to one where the TID-to-link mapping IE 200 includes an Expected Duration in the subfield 212, and may otherwise be set to zero. The Link Mapping Size subfield 224 may be set to one where the Link Mapping subfields (e.g., subfields 214A through 214H) are using one octet. The Link Mapping Size subfield 224 may be set to zero where the Link Mapping subfields are using two octets. The Reserved subfield 226 may be reserved.

The Link Mapping Presence Indicator subfield 228 indicates whether the Link Mapping of TID n field (214A through 214H) is present in the TID-To-Link Mapping information element 200 (i.e., it identifies the TID(s) for which the mapping is provided in the information element 200). A value of 1 in bit position n of the Link Mapping Presence Indicator subfield 228 indicates that the Link Mapping of TID n field is present in the TID-To-Link Mapping information element 200. Otherwise, the Link Mapping of TID n field is not present in the TID-To-Link Mapping information element 200. When the Default Link Mapping subfield is set to 1, this subfield may not be present.

The Mapping Switch Time field 210 may be present when the TID-To-Link Mapping IE 200 is transmitted by an AP affiliated with an AP MLD in a beacon or probe response frame and the indicated TID-to-link mapping is not yet established; otherwise the Mapping Switch Time field 210 is not present. The absence of Mapping Switch Time field 210 in the TID-To-Link Mapping IE 200 in a beacon or probe response frame transmitted by an AP affiliated with an AP MLD may indicate that the indicated TID-to-link mapping is already established.

The 2 octet Mapping Switch Time field 210 is set to the time at which the new mapping is established using as a time-base the value of the TSF corresponding to the BSS identified by the BSSID of the frame containing the TID-To-Link Mapping element: i.e., bits 10 to 25 of the TSF. The Mapping Switch Time does not decrease from one beacon to the next. The Expected Duration field 212 is present if the TID-To-Link Mapping element 200 is carried in a beacon or a probe response frame transmitted by an AP affiliated with an AP MLD, and is not present otherwise.

In cases in which the AP MLD seeks to replace one global TID-to-link mapping that is already in place with another global TID-to-link mapping, the AP MLD may include two TID-To-link mapping IEs in the beacon and probe response frames. One of the TID-to-link mapping IEs may be associated with the established TID-to-link mapping and the other TID-to-link mapping IE may be associated with the TID-to-link mapping that is to replace the established TID-to-link mapping. In these cases, the AP MLD may not include the Mapping Switch Time field in the TID-To-link Mapping IE associated with the established mapping and may include the Mapping Switch Time field in the TID-To-Link Mapping IE associated with the new mapping. Such may indicate an advertised TID-to-link mapping that will be established in the future. The value of the Expected Duration field of the existing TID-To-Link Mapping IE may indicate a remaining duration that ends at the same time as indicated by the Mapping Switch Time field of the new TID-To-Link mapping IE. These concepts are illustrated in more detail herein.

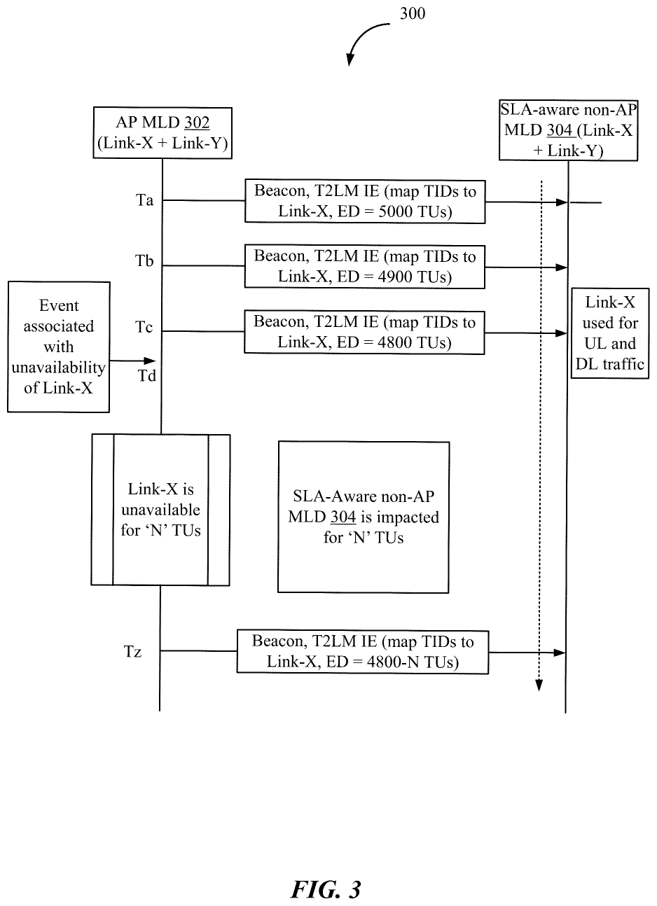

FIG. 3 shows a sequence diagram depicting networking communications 300 between an AP MLD 302 and a non-AP MLD 304 (also referred to herein as the STA 304 or the STA MLD 304). The AP MLD 302 and the non-AP MLD 304 may respectively be an example of the AP 102 and the STA 104 discussed with reference to FIG. 1. Each of the AP MLD 302 and the non-AP MLD 304 is capable of operating on multiple links, such as on Link-X and Link-Y. The non-AP MLD 304 may be an SLA-aware device.

In the example of FIG. 3, the AP MLD 302 has, in a beacon frame, advertised TID-to-link mapping that maps all TIDs to Link-X. In the illustrated example, at time Ta, the TID-to-link mapping has an Expected Duration (ED) of 5,000 time units (TUs). That is, all TIDs are mapped to Link-X for 5,000 TUs (or 50 TBTTS) for both uplink (UL) and downlink (DL). This is represented by the TID-to-link mapping IE included in a beacon frame communicated by the AP MLD 302 to the STA 304 at time Ta. At the next TBTT at time Tb, the TID-to-link mapping IE has an Expected Duration of 4,900 TUs. At the next TBTT at time Tc, the TID-to-link mapping IE has an Expected Duration of 4,800 TUs.

At time Td, which in this example is after Tc and before the Expected Duration of the TID-to-link mapping IE decreases to 4,700 TUs, an event occurs. The event may be associated with an unavailability of Link-X. The event may be associated with the unavailability of the home channel on which the STA MLD 304 is communicating with the AP MLD 302 on Link-X. As discussed herein, the event may be associated with the detection of radar on Link-X, an off-channel transmission associated with Link-X, interference on Link-X, an Automatic Channel Selection scan associated with Link-X, a Quiet information element associated with Link-X, or any other event associated with the unavailability of Link-X.

Assume that in view of the event, Link-X is unavailable for N TUs. For example, a home channel on Link-X on which the AP 302 and STA 304 were communicating may be rendered unavailable for N TUs in association with the event. After N time units, at time Tz, the AP 302 and the STA 304 may resume communications over the Link-X. The Expected Duration of the TID-to-link mapping may now be 4,800 TUs-N TUs.

The unavailability of Link-X for N TUs may impact the operation of the STA 304 and may cause the SLA associated with the STA 304 to be breached. It may be desirable to avoid a breach of the SLA associated with the STA 304. Example implementations of the disclosure may allow for proactive action to be taken such that upcoming SLA breaches associated with unavailability of a given link are avoided.

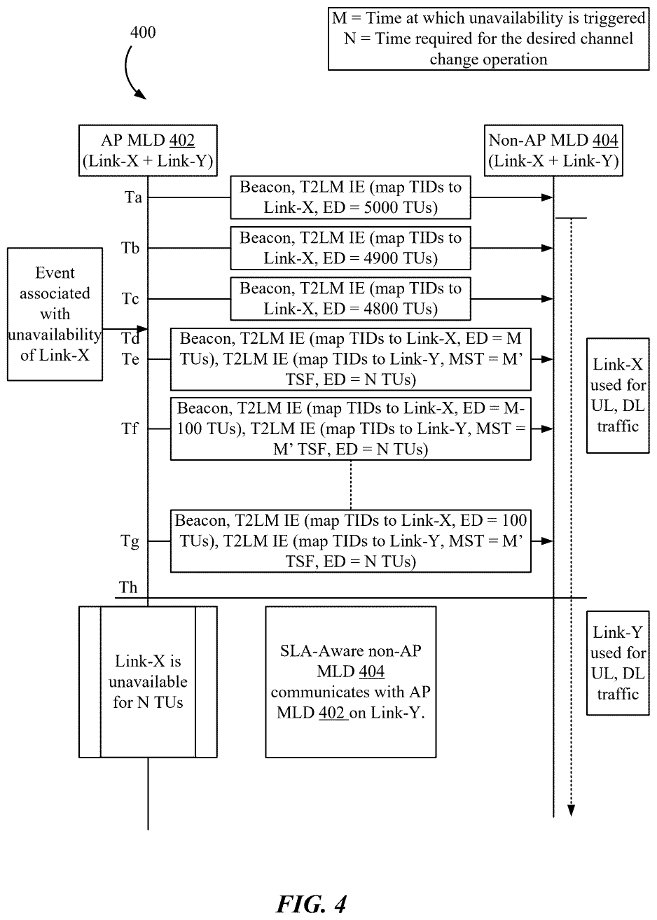

FIG. 4 shows a sequence diagram depicting networking communications 400 between an AP MLD 402 and a non-AP MLD (or an STA MLD) 404, according to some aspects. The AP MLD 402 and the non-AP MLD 404 may respectively be an example of the AP 102 and the STA 104 discussed with reference to FIG. 1. Each of the AP MLD 402 and the non-AP MLD 404 is capable of operating on multiple links, such as on Link-X and Link-Y. The non-AP MLD 404 may be an SLA-aware device.

Akin to the example of FIG. 3, the AP MLD 402 is shown as having mapped all TIDs associated with the STA 304 to Link-X using a TID-to-link mapping mechanism. In the example of FIG. 4, as in FIG. 3, the TID-to-link mapping to Link-X has an Expected Duration (ED) of 5,000 TUs. This is represented by the TID-to-link mapping IE included in a beacon frame communicated by the AP MLD 402 to the STA 404 at time Ta. At the next TBTT at time Tb, the TID-to-link mapping IE has an Expected Duration of 4,900 TUs. At the next TBTT at time Tc, the TID-to-link mapping IE has an Expected Duration of 4,800 TUs.

As in the example illustrated in FIG. 3, at time Td, an event occurs. The event may be associated with the unavailability of Link-X and may impact Link-X for N TUs. The AP 402 may identify (e.g., detect) this event.

In the example of FIG. 3, no proactive or other remedial action was taken in view of the event. Therefore, the TIDs remained mapped to Link-X for the duration of the unavailability of the Link-X, and consequently, the STA 304 was precluded from communicating with the AP MLD 302 for N TUs. In the example of FIG. 4, conversely, the AP MLD 402 may, at time Te, transmit a new TID-to-link mapping scheme to the non-AP MLD 404.

Assume that the event will cause Link-X, e.g., the home channel, to become unavailable in M TUs (i.e., there are M TUs remaining before Link-X becomes unavailable). Assume further that Link-X will become available again after N TUs. In an example, based on this information, i.e., based on when Link-X will become unavailable and the duration of the unavailability, the AP MLD 402 may transmit the new TID-to-link mapping scheme to the non-AP MLD 404 at time Te. The new TID-to-link mapping scheme may include two TID-to-link mapping IEs-one associated with the established mapping of the TIDs to Link-X, and another TID-to-link mapping IE configured to map the TIDs to Link-Y in association with the event that will render Link-X unavailable.

In more detail, the TID-to-link mapping IE associated with Link-X may include an Expected Duration of M TUs. Thus, the Expected Duration of the established TID-to-link mapping to Link-X may, in this example, change from 4,800 TUs at time Tc to M TUs at time Te in view of the event. Moreover, the TID-to-link mapping associated with Link-Y may include a Mapping Switch Time of M′ TSF, which may correspond to M TUs. Thus, in M TUs, when Link-X becomes unavailable, the TIDs may no longer remain mapped to Link-X but may instead be mapped to Link-Y. The Expected Duration of the TID-to-link mapping to Link-Y may be N TUs. In this way, once the TID-to-link mapping to Link-Y takes effect, it may remain valid for the duration of the unavailability of Link-X. In some examples, the Expected Duration of the TID-to-link mapping to Link-Y may be at least N TUs, i.e., may be greater than or equal to N TUs.

At time Tf, in the subsequent beacon, the Expected Duration of the TID-to-link mapping IE associated with Link-X may decrease by 1 TBTT to M-100 TUs. The value of the Mapping Switch Time of the TID-to-link mapping IE associated with Link-Y may not change because, as discussed above, the Mapping Switch Time value is a fixed value that does not change from beacon to beacon (as will be understood, however, the Mapping Switch Time of the TID-to-link mapping IE associated with Link-Y may, in effect, continue to track the Expected Duration of the TID-to-link mapping IE associated with Link-X). The Expected Duration of the TID-to-link mapping associated with Link-Y may remain at N TUs.

In the illustrated example, at time Tg, one TBTT remains before Link-X is rendered unavailable. Therefore, the TID-to-link mapping associated with Link-X in the beacon transmitted at time Tg may indicate that the Expected Duration of the mapping to Link-X may expire at the next beacon.

At time Th, Link-X may become unavailable in association with the event identified by the AP MLD 402. In line with the TID-to-link mapping associated with Link-Y, the TIDs may be mapped to Link-Y, which may allow the non-AP MLD 404 to communicate with the AP MLD 402 over Link-Y. The unavailability of Link-X, to which the TIDs were mapped prior to the event, may therefore be addressed by mapping the TIDs to Link-Y unaffected by the event. In this manner, the AP MLD 402 may employ a TID-to-link mapping scheme to proactively avoid a possible upcoming breach of the SLA associated with STA 404. The TID-to-link mapping may take into account the unavailability information of Link-X, which may indicate a start time of the unavailability of the link and an expected duration of this unavailability.

As discussed herein, a link may be rendered unavailable in association with one or more of a number of events. The techniques described with reference to FIG. 4 may be generally applicable to avoid upcoming SLA breaches associated with different types of such events.

Consider, for example, a situation in which the event is or is associated with radar detection. An AP operating in certain parts of the 5 GHz U-NII-2 band, known as Dynamic Frequency Selection (DFS) channels, may require active radar detection. In general, when an AP is on a DFS channel and detects a radar signal on that channel, it must vacate that channel and move to a new channel within a few seconds. For example, if an AP is communicating with an STA on a DFS channel (e.g., channel 100), and the AP detects that a radar has also begun using that DFS channel (channel 100 in this example), the AP is required to initiate a channel changeover in view of the detected radar on the DFS channel. This forced changeover may result in a service interruption to any clients served by the AP, as the clients must also change channels, to continue their wireless connection to the AP. An AP may announce the upcoming channel change via a Channel Switch Announcement information element.

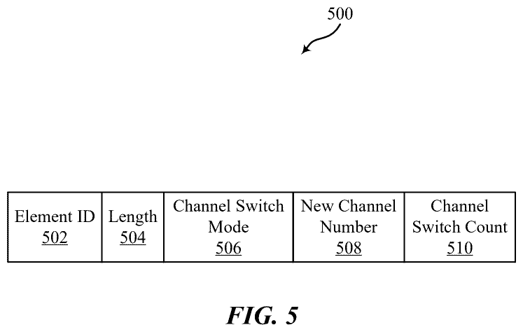

FIG. 5 shows an example Channel Switch Announcement (CSA) information element 500. The format of the CSA IE 500 may conform to an IEEE 802.11 standard, such as that defined by the IEEE 802.11-2016 specification or amendments thereof including, but not limited to, 802.11ah, 802.11ad, 802.11ay, 802.11ax, 802.11az, 802.11ba, and 802.11be. The CSA IE 500 may have an Element ID field 502, a Length field 504, a Channel Switch Mode field 506, a New Channel Number field 508, and a Channel Switch Count field 510. The Element ID field 502 may have a value of 37. The Length field 504 may indicate a length of the CSA IE 500. The Channel Switch Mode field 506 may indicate whether any requirements are imposed on transmission. For example, a value of zero of the Channel Switch Mode field 506 may indicate that an STA that receives the CSA IE 500 has no requirements imposed on transmission. A value of one of the Channel Switch Mode field 506, conversely, may indicate that no frames will be transmitted until the CSA takes effect. The New Channel Number field 508 may indicate the value of the new channel. The Channel Switch Count field 510 may indicate the number of Target Beacon Transmission Time (TBTTs) remaining prior to the switch to the new channel.

Another requirement associated with operation on DFS channels is the channel availability check (CAC), which mandates that an AP whose radio switches to a DFS channel must first listen on the channel for the presence of radar signals for a period of time before it can resume transmission. This CAC period ranges from 60 seconds to 600 seconds, depending on the channel and regulatory domain. During the CAC period, the radio of an AP must operate in a receive-only mode, and thus, is unable to serve its client devices. Such disruptions in performance may cause an SLA associated with an STA to be breached.

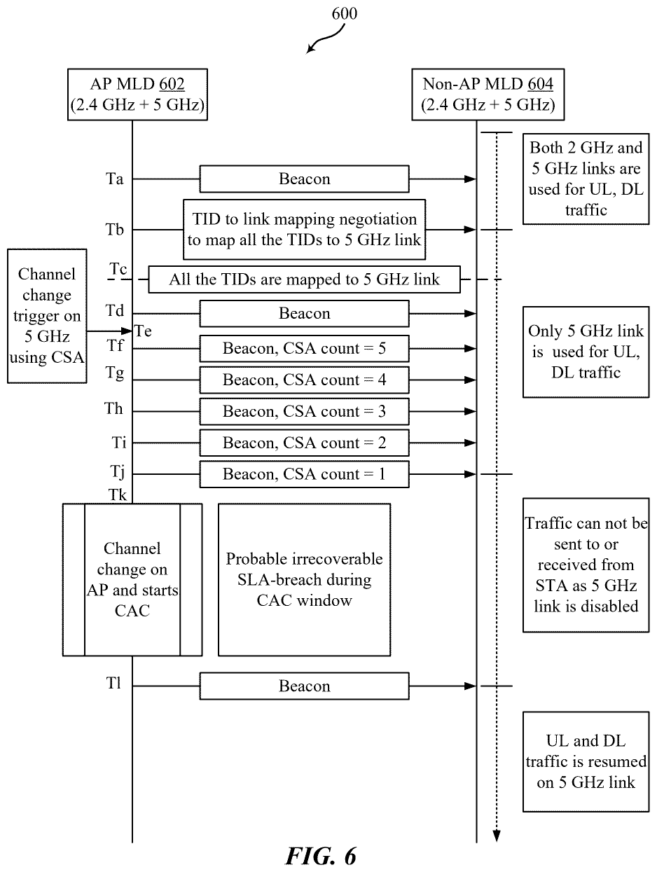

Consider now a situation in which the event is associated with detecting radar on a link (e.g., the 5 GHz link) to which the TIDs are mapped. FIG. 6 shows a sequence diagram depicting networking communications between an AP MLD 602 and a non-AP MLD 604 being disrupted due to radar detection. The AP MLD 602 and the non-AP MLD 604 may respectively be an example of the AP 102 and the STA 104 discussed with reference to FIG. 1. Each of the AP MLD 602 and the non-AP MLD 604 is capable of operating on multiple links, such as on the 2.4 GHz link and the 5 GHz link in this example. The non-AP MLD 604 may be an SLA-aware device.

At time Ta, the AP MLD 602 and the non-AP MLD 604 are shown to be communicating with each other on both the 2.4 GHz and the 5GHz links. At time Tb, the AP MLD 602 initiates mapping of all the TIDs to the 5 GHz link. At time Tc, all TIDs are mapped to the 5 GHz link.

At time Td, the AP MLD 602 communicates with the non-AP MLD 604 on the 5 GHz link. The beacon at time Td may include a TID-to-link mapping IE indicating that the TIDs are mapped to 5 GHz. Assume that the home channel on the 5 GHz link on which the AP MLD 602 and non-AP MLD 604 are communicating is a DFS channel. In the illustrated example, at time Te, the AP MLD 602 detects radar on the 5 GHz link.

Detection of the radar by the AP MLD 602 triggers a Channel Switch Announcement (CSA). In the illustrated example, the CSA count is 5 TBTTs (which equals 500 TUs). The CSA count is shown decrementing from 5 TBTTs at Tf to 4, 3, 2, and 1 at times Tg, Th, Ti, and Tj, respectively.

At the next TBTT, at time Tk, the channel change operation on the AP MLD 602 is initiated. Assume that the new channel is also a DFS channel. In such case, the AP MLD 602 initiates the Channel Availability Check (CAC), which, as noted, may range from 60 seconds to 600 seconds. The CAC may halt service to the non-AP MLD 604 and the AP MLD 602 may be rendered unable to communicate with the non-AP MLD 604 on the same or a different channel on the 5 GHz link until the CAC process ends. Further, while an SLA breach-detection algorithm may be configured to map the TIDs to an available link in view of the unavailability of the 5 GHz link, it may fail to do so because communications between the STA and the AP MLD may be halted once the CAC begins (i.e., once the CAC process begins, it may not be possible for the SLA breach-detection algorithm to map all TIDs to the 2.4 GHz link). The SLA associated with the non-AP MLD 604 may resultantly be breached. At time Tl, once the CAC process is completed, the AP MLD 602 may resume communications with the non-AP MLD 604 on the 5 GHz link.

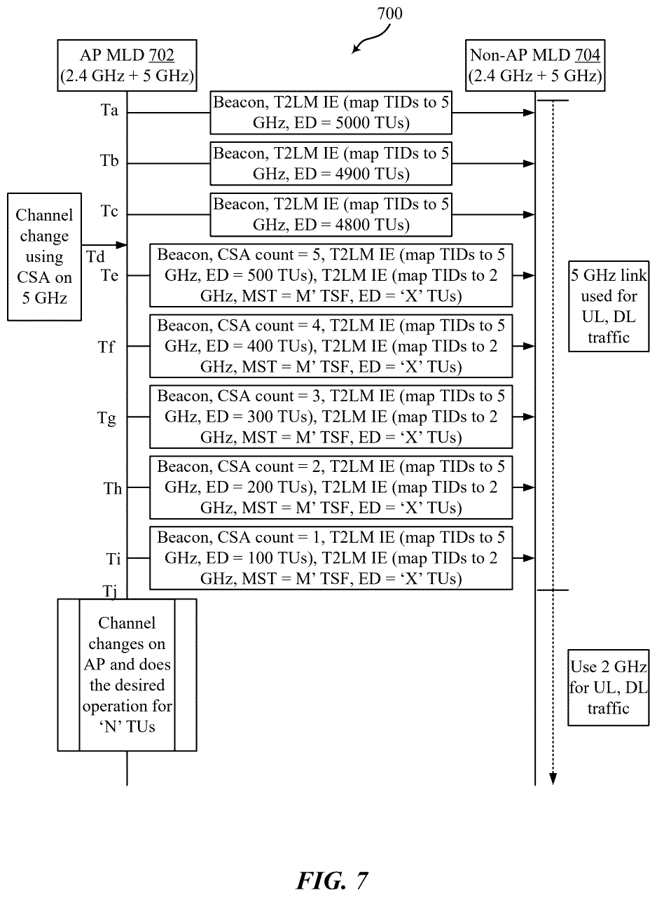

FIG. 7 shows a sequence diagram depicting networking communications 700 between an AP MLD 702 and a non-AP MLD 704, according to some aspects. The AP MLD 702 and the non-AP MLD 704 may respectively be an example of the AP 102 and the STA 104 discussed with reference to FIG. 1. Each of the AP MLD 702 and the non-AP MLD 704 is capable of operating on multiple links, such as on the 2.4 GHz link and the 5 GHz link in this example. The non-AP MLD 704 may be an SLA-aware device. As discussed herein, and in contrast to the networking communications 600 in FIG. 6, an SLA breach may be avoided in the networking communications 700 notwithstanding the detection of radar on the link on which the AP MLD 702 and the non-AP MLD 704 are communicating.

At time Ta, the AP MLD 702 is shown to have mapped all the TIDs to the 5 GHZ link. The Expected Duration of this TID-to-link mapping at time Ta is 5,000 TUs. At the next beacon, at time Tb, the Expected Duration of this TID-to-link mapping decreases to 4,900 TUs. At the next beacon, at time Tc, the Expected Duration of this TID-to-link mapping decreases to 4,800 TUs. Assume that the home channel on the 5 GHz link on which the AP MLD 702 and non-AP MLD 704 are communicating is a DFS channel. In the illustrated example, at time Td, the AP MLD 702 detects radar on the 5 GHz link, e.g., on the home channel.

At time Te, in view of the event (detection of a radar in this case), a Channel Switch Announcement (CSA) process is initiated. The AP MLD 702 thus includes a CSA IE in the beacon frame at time Te having a Channel Switch Count of 5 TBTTs. The AP MLD 702 also includes in the beacon frame two TID-to-link mapping IEs-one associated with the established (5 GHz) link, and the other associated with another available link (the 2.4 GHz link in this example). More specifically, the AP MLD 702: (a) sets the Expected Duration of the TID-to-link mapping IE associated with the established 5 GHz mapping to 500 TUs such that the Expected Duration of the established mapping now aligns with the Channel Switch Count of 5 TBTTs; and (b) sets the MST of the other TID-to-link mapping IE associated with the 2.4 GHZ mapping to M′ TSF, where M′ TSF also aligns with the Channel Switch Count of 5 TBTTs. The Expected Duration of the new TID-to-link mapping IE associated with the 2.4 GHz link may be set such that the TIDs remain mapped to the 2.4 GHz link at least until the 5 GHz link becomes available again. For example, in the illustrated example, the Expected Duration of X TUs of the TID-to-link mapping IE for the 2.4 GHz link may be associated with the Channel Availability Check time or other time (e.g., the time it takes to calibrate a channel after the Channel Switch Announcement) for which the 5 GHz link is unavailable.

At the next beacon, at time Tf, the Channel Switch Count decreases to 4 TBTTs. The Expected Duration of the TID-to-link mapping IE associated with the established mapping (i.e., the 5 GHz mapping in this example) correspondingly decreases to 400 TUs and continues to track the Channel Switch Count. The Mapping Switch Time of the TID-to-link mapping associated with the new mapping (i.e., the 2.4 GHz mapping in this example), as discussed above, is a fixed value, and as such, does not change from beacon to beacon; however, the Mapping Switch Time of the TID-to-link mapping IE associated with the 2.4 GHz link, in effect, continues to align with the Expected Duration of the established TID-to-link mapping and the Channel Switch Count.

At the next successive TBTTs, at time Tg, time Th, and time Ti, the Channel Switch Count decreases to 3 TBTTs, 2TBTTs, and to 1 TBTT, respectively. The Expected Duration of the TID-to-link mapping IE associated with the established mapping (5 GHz) and the Mapping Switch Time of the TID-to-link mapping IE associated with the new mapping (2.4 GHz) continue to correspond to the Channel Switch Count at times Tg, Th, and Ti.

At time Tj, the channel change is triggered and the 5 GHz link becomes unavailable for a time period (e.g., the 5 GHz link may become unavailable because of a Channel Availability Check in cases in which the new channel is a DFS channel, or may become unavailable for a calibration time of the new channel in cases in which the new channel is not a DFS channel). Generally concurrently, the TID-to-link mapping associated with the 5 GHZ link expires, and the TID-to-link mapping associated with the 2.4 GHz link takes effect. Thus, the AP MLD 702 continues to communicate with the non-AP MLD 704, now on the 2.4 GHZ link. Breach of the SLA associated with the non-AP MLD 704 may thus be avoided. When the 5 GHz link becomes available again, or some time thereafter, the AP MLD 702 may map the TIDs back to the 5 GHz link.

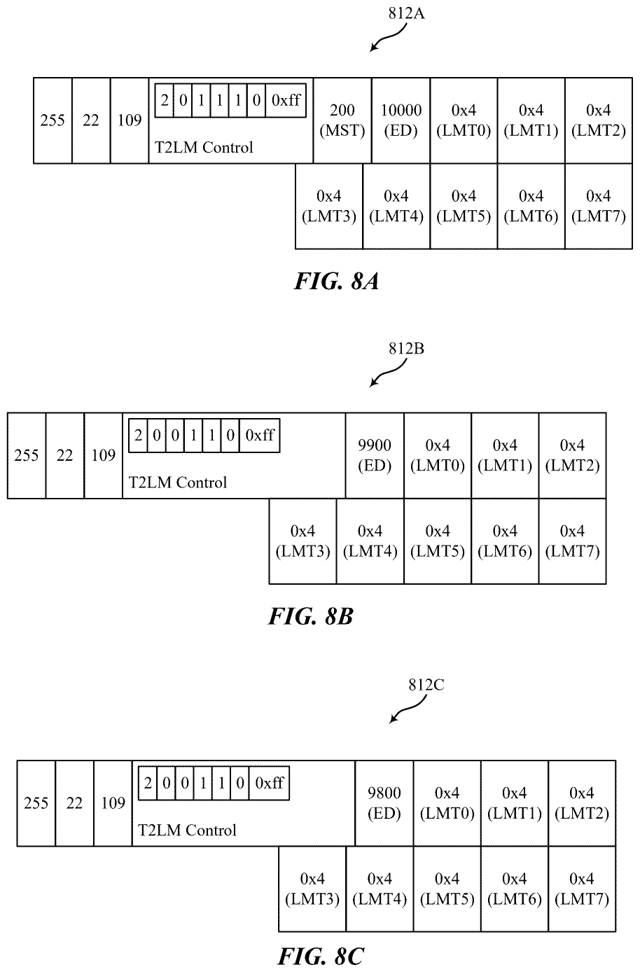

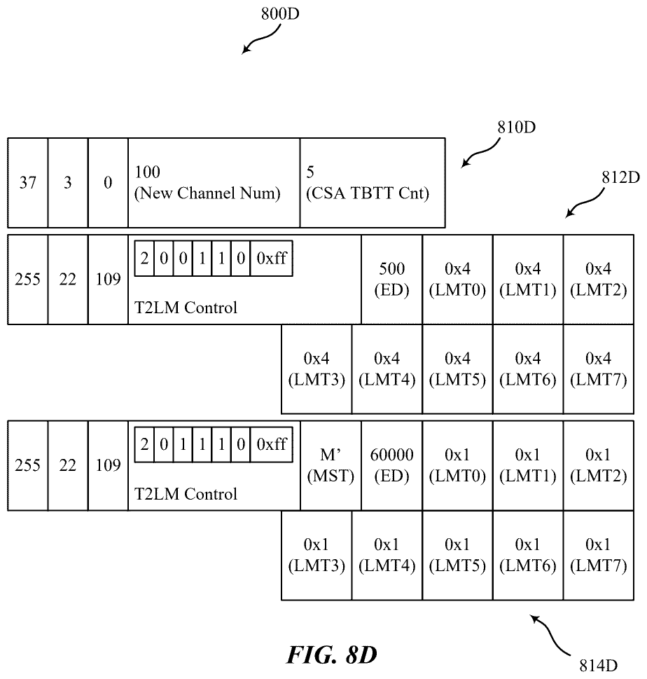

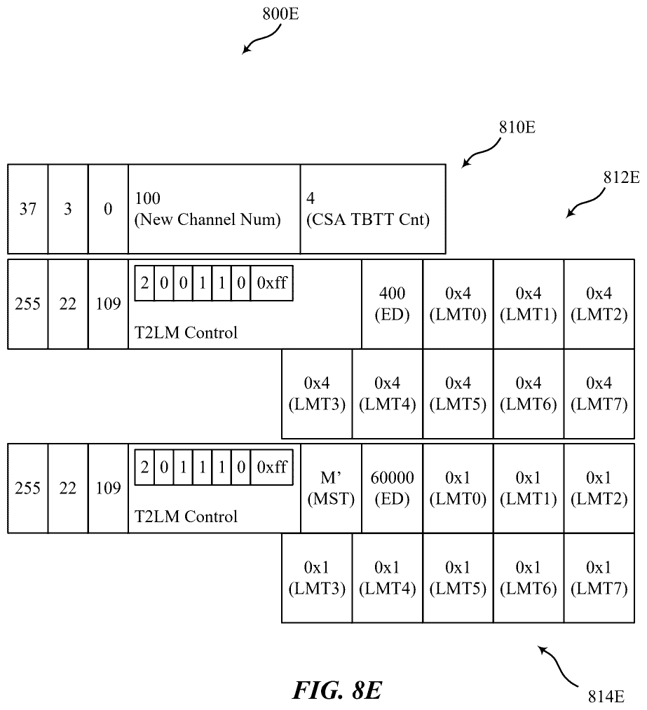

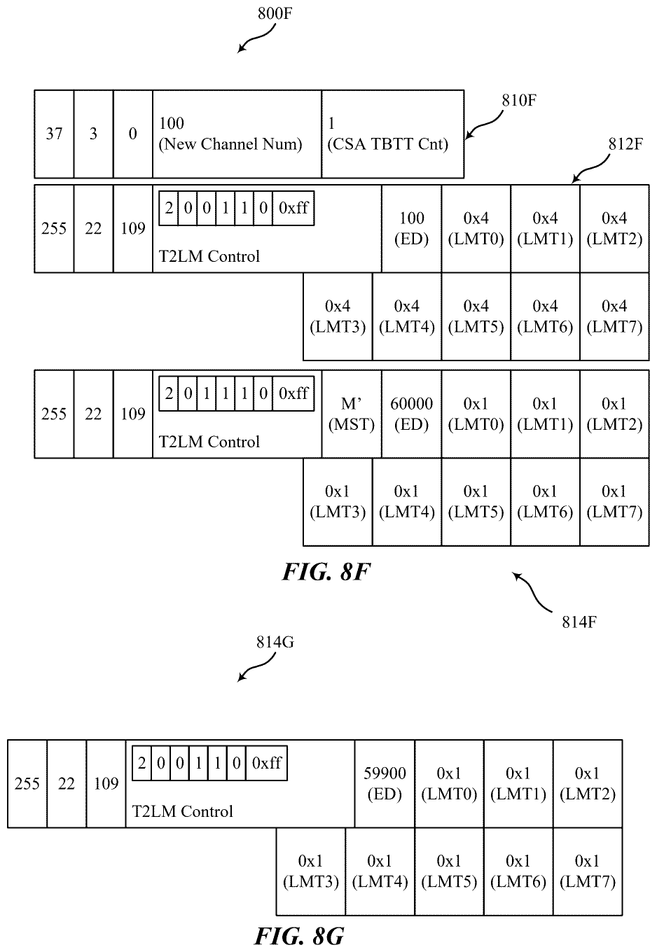

FIGS. 8A through 8G show example TID-to-link and CSA information elements usable to take proactive corrective action in the event a radar is detected on a link, according to some aspects. Assume, for example, that an AP MLD, such as the AP MLD 702 of FIG. 7, and a non-AP MLD, such as the non-AP MLD 704 of FIG. 7, are communicating with each other over the 2.4 GHz link and the 5 GHz link. The 2.4 GHz link is configured in channel 1 and the 5 GHz link is configured in channel 120, a DFS channel. The AP MLD then initiates the mapping of all TIDs to the 5 GHz link by advertising a TID-to-link mapping IE in a beacon frame. In this example, assume the Mapping Switch Time is 200 TSF and the Expected Duration is 10,000 TUs.

Focus is directed to FIG. 2 that identifies the fields of an example TID-to-link mapping IE (the TID-to-link mapping IE 200 in FIG. 2), and to FIG. 8A which illustrates a TID-to-link mapping IE 812A. In the TID-to-link mapping IE 812A, the Element Id is 255, the Length is 22, and the Element ID Extension is 109. In the TID-to-link mapping Control field: the Direction has a value of two, which indicates bidirectional mapping; the Default Link Mapping has a value of zero, which indicates the IE 812A includes mapping information and the mapping is not default mapping; the Mapping Switch Time Present has a value of one, indicating a Mapping Switch Time is included in the IE 812A; the Expected Duration Present has a value of one, indicating an Expected Duration is included in the IE 812A; the Link Mapping Size subfield has a value of one, indicating that the Link Mapping fields are one octet; the Reserved field has a value of zero; and the Link Mapping Presence Indicator indicates that each of the TIDs 0 to 7 are being mapped via the Link Mapping elements. The Mapping Switch Time has a value of 200 TSF, indicating that the instant TID-to-link mapping is configured to take effect in 200 TSF. The Expected Duration has a value of 10,000 TUs, indicating that the instant mapping, once implemented, is configured to have a duration of 10,000 TUs. The Link Mapping of TID0 to TID7 fields each have a hexadecimal value of 0x4, which indicates the TIDs are to be mapped to the 5 GHz link (bit position two indicates 5 GHZ). The TID-to-link mapping IE 812A may be added to successive beacons until the Mapping Switch Time expires (Note that the value of the Mapping Switch Time may be a fixed value and may not change from beacon to beacon).

FIG. 8B shows a TID-to-link mapping IE 812B transmitted after the TID-to-link mapping to 5 GHz of the TID-to-link mapping IE 812A of FIG. 8A has taken effect at the expiration of the Mapping Switch Time. As can be seen, the TID-to-link mapping IE 812B does not include a field for Mapping Switch Time, and the associated field in the TID-to-link mapping Control (i.e., the Mapping Switch Time Present field) now has a value of zero. The absence of the Mapping Switch Time in the TID-to-link mapping IE 812B in the beacon frame indicates that the mapping has taken effect. Further, the Expected Duration is decreased by 1 TBTT (or 100 TUs).

FIG. 8C shows a TID-to-link mapping IE 812C included in the next beacon. The Expected Duration of the TID-to-link mapping IE 812C has decreased by 1 TBTT (100 TUs) relative to the TID-to-link mapping IE 812B.

Assume that a radar is detected on the 5 GHz link, triggering a Channel Switch Announcement configured to implement a channel change after a Channel Switch Count. As discussed with respect to FIG. 6 above, if no corrective action is taken in this situation, an SLA associated with an SLA-aware device may be breached when the 5 GHz link subsequently becomes unavailable for a time period in association with the detection of radar on the link. In view of this radar detection event, the AP MLD may, in addition to a CSA IE, include in the beacon two TID-to-link mapping IEs-one associated with the established mapping to the 5 GHz link and the other associated with a new mapping to the 2.4 GHz link. These IEs 800D are illustrated in FIG. 8D.

Specifically, FIG. 8D shows a CSA IE 810D, a TID-to-link mapping IE 812D associated with the established mapping (the 5 GHz link in this example), and a TID-to-link mapping IE 814D associated with the new mapping (the 2.4 GHz link in this example). The CSA IE 810D (see also FIG. 5 for the fields of a CSA IE) has a Channel Switch Count of 5 TBTTs and the new channel number is channel 100. The TID-to-link mapping IE 812D associated with the established 5 GHz band now has an Expected Duration 500 TUs that aligns with the Channel Switch Count of the CSA IE 810D. Thus, as can be seen from FIG. 8C to FIG. 8D, the AP MLD has caused the Expected Duration of the TID-to-link mapping IE associated with the 5 GHz band to reset to 500 TUs such that the Expected Duration of this IE 812D is now the same as the Channel Switch Count of the CSA IE 810D. The TID-to-link mapping IE 814D associated with the 2.4 GHz Band has a Mapping Switch Time of M′ TSF that likewise aligns with the Channel Switch Count (i.e., M′ TSF=5 TBTTs) of the CSA IE 810D. In this example, the Expected Duration of the 2.4 GHz mapping is 60,000 TUs.

Assume that the IEs 800D are associated with beacon Y. In the next beacon, beacon Y+1, the AP may include IEs 800E shown in FIG. 8E, specifically, a CSA IE 810E, a TID-to-link mapping IE 812E associated with the established mapping, and a TID-to-link mapping IE 814E associated with the new mapping. The Channel Switch Count of the CSA IE 810E is shown to have decreased from 5 to 4 TBTTs. The Expected Duration of the TID-to-link mapping IE 812E associated with the 5 GHz link is likewise shown to have decreased to 400 TUs to align with the Channel Switch Count of the CSA IE 810E. The Mapping Switch Time of the TID-to-link mapping IE 814E associated with the 2.4 GHz link, a fixed value, continues to track the Channel Switch Count of the CSA IE 810E.

At beacon Y+4, the AP MLD may include the IEs 800F in FIG. 8F. Specifically, the Channel Switch Count of the CSA IE 810F is now one TBTT, and tracks the Expected Duration 100 TUs of the TID-to-link mapping IE 812F associated with the 5 GHz Band. The Mapping Switch Time of the TID-to-link mapping IE 814F associated with the 2.4 GHz link continues to track the Channel Switch Count of the CSA IE 810F.

At beacon Y+5, the channel switch occurs. The Expected Duration of the TID-to-link mapping IE 812F associated with the 5 GHz expires, together with the Mapping Switch Time of the TID-to-link mapping IE 814F associated with the 2.4 GHz mapping. The AP MLD and all connected STA MLDs may therefore map the TIDs to the 2.4 GHz link. At beacon Y+5, a CSA IE and a TID-to-link mapping IE associated with the 5 GHz link may no longer be included. The format of a TID-to-link mapping IE 814G associated with the 2.4 GHz link at beacon Y+5 is shown in FIG. 8G. As shown, the Expected Duration of the TID-to-link mapping IE 814G has decreased by 100 TUs to 59,900 TUs. The Expected Duration may successively decrease in successive beacons. When the 5 GHz link becomes available, or sometime thereafter, the TIDs may be mapped to the 5 GHz link if desired. By proactively using TID-to-link signaling in view of an event associated with the upcoming breach of an SLA based at least in part on the unavailability of a link, breach of the SLA may be avoided.

FIGS. 7 and 8A-8G are associated with situations in which the established TID-to-link mapping (e.g., the mapping to the 5 GHz link in FIG. 7 and FIGS. 8A-8G) is global TID-to-link mapping-i.e., is established by the AP in beacons or probe responses and is applicable to all client devices in the BSS. As noted above, the TID-to-link mapping may conversely be peer-to-peer mapping, where the mapping to a link is not established by the AP in beacons but via individual peer-to-peer communications with one or more STAs. In cases in which the AP has established the TID-to-link mapping using unicast TID-to-link mapping frames and the AP is not advertising any TID-to-link mapping in beacons or probe response frames, the AP may establish a new global TID-to-link mapping in response to an event to cause the established peer-to-peer mapping to be discarded.

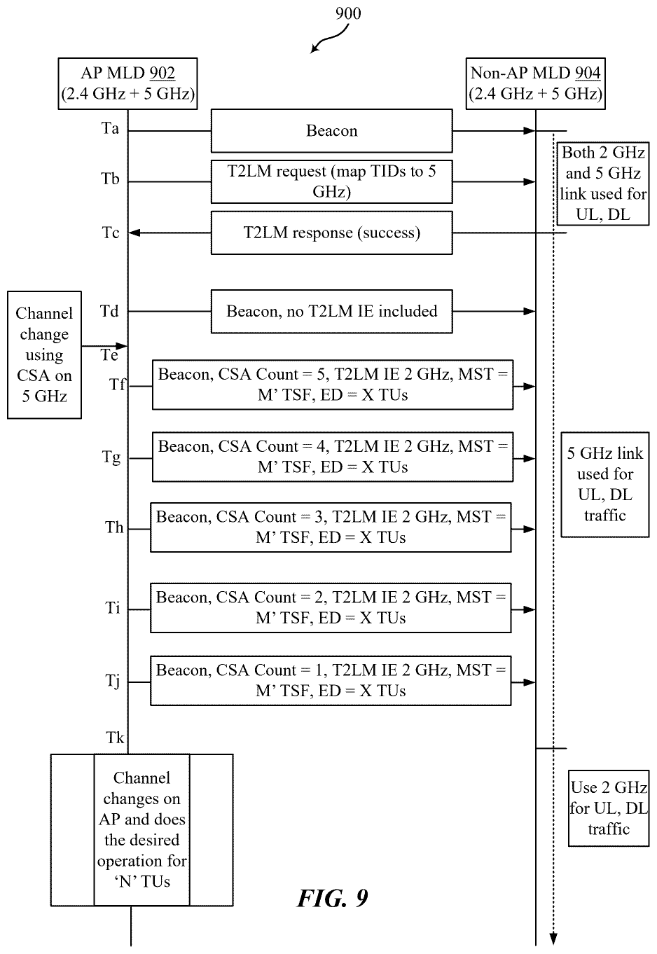

FIG. 9 shows a sequence diagram depicting example networking communications between an AP MLD and a non-AP MLD, according to some aspects. As discussed herein, in the example of FIG. 9, the AP MLD and the non-AP MLD have mapped TIDs to the 5 GHZ link using peer-to-peer mapping. The AP MLD 902 and the non-AP MLD 904 may respectively be an example of the AP 102 and the STA 104 discussed with reference to FIG. 1. Each of the AP MLD 902 and the non-AP MLD 904 is capable of operating on multiple links, such as on the 2.4 GHz link and the 5 GHz link in this example. The non-AP MLD 904 may be an SLA-aware device.

At time Ta, the AP MLD 902 may send a beacon. At this time, the AP MLD 902 and non-AP MLD 904 may be using both the 2.4 GHz link and the 5 GHz link to communicate with each other. At time Tb, the AP MLD 902 may initiate a peer-to-peer TID-to-link mapping with the non-AP MLD 904. At time Tc, the non-AP MLD 904 may communicate that the TIDs are mapped to the 5 GHz link, and communication between the AP MLD 902 and the non-AP MLD 904 may now be solely on the 5 GHz link.

At time Td, the AP MLD 902 may transmit a beacon that is devoid of any TID-to-link mapping IE. At time Te, an event associated with an upcoming unavailability of the 5 GHZ link may be identified by the AP MLD 902. Specifically, in this example, the AP MLD 902 may detect radar on the 5 GHz link, which may trigger a Chanel Switch Announcement.

At time Tf, the AP MLD 902 may include in the beacon a Channel Switch Announcement IE. The Channel Switch Count of the CSA IE is shown to be five TBTTs. In conjunction with the CSA IE, the AP MLD 902 may include a TID-to-link mapping IE configured to globally map the TIDs to the 2.4 GHz link. The Mapping Switch Time of the TID-to-link mapping IE may be M′ TSF, which may align with the Channel Switch Count of the CSA IE.

At the next beacon, at time Tg, the Channel Switch Count of the CSA IE may decrease to four TUs. The Mapping Switch Time of the TID-to-link mapping IE, a fixed value, may continue to align with the Channel Switch Count of the CSA IE.

At time Th, Ti, and Tj, the Channel Switch Count may respectively decrease to three TUs, two TUs, and one TU, and the Mapping Switch Time of the TID-to-link mapping IE may continue to effectively align with the Channel Switch Count. At time Tk, the channel switch on the 5 GHz link may be initiated and the TIDs may be globally mapped to the 2.4 GHz link (i.e., the global TID-to-link mapping to 2.4 GHz in the beacon frame may cause the peer-to-peer mapping to the 5 GHz link to be discarded). Thus, the non-AP MLD 904 may continue to operate generally uninterrupted on the 2.4 GHz link notwithstanding the unavailability of the 5 GHz link to which the TIDs were previously mapped. A breach of the SLA associated with the non-AP MLD 904 may thus be avoided.

Some events associated with the unavailability of a link may be link-specific (i.e., may be associated with the unavailability of a particular link (such as the 2.4 GHz link)) or a subset of links. For example, detection of radar is an event that may be specific to the 5 GHZ link. Other events may not be link-specific, i.e., may be associated with the unavailability of any link. Off-channel transmission is an example of such an event that may be associated with the unavailability of any link (e.g., any of the 2.4 GHz link, the 5 GHz link, the 6 GHz link, et cetera).

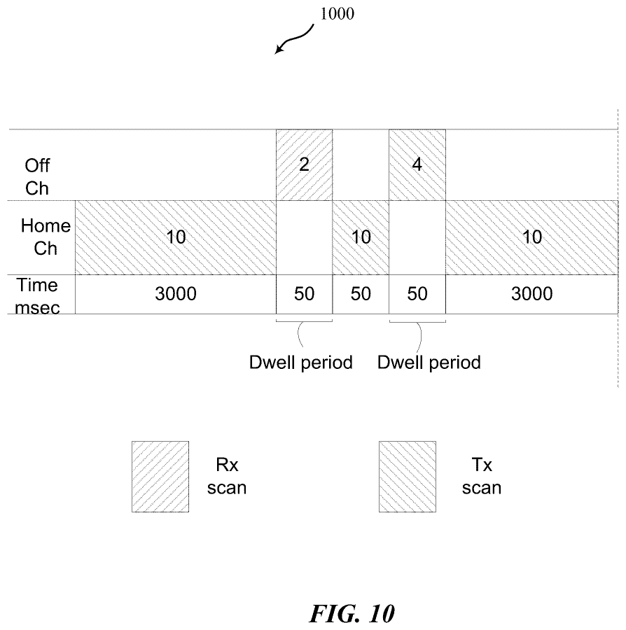

FIG. 10 shows a schematic 1000 illustrating example off-channel scanning. In this example, the home channel is channel 10 (2.4 GHz link) and an AP MLD may communicate with one or more STA MLDs on the home channel. From time to time, the AP MLD may go off the home channel and scan on a different channel. The AP MLD may do so because of client requirements, to scan for a channel with reduced interference, or for another reason. When the AP MLD moves to a channel other than the home channel (the off-channel), the AP may receive data on the off-channel or send active probes on that off-channel. But since the AP may be connected to other devices on the home channel, the service to these STAs may be impacted.

In the illustrated example, the AP MLD operates on the home channel, channel 10, for 3,000 milliseconds. Then, the AP MLD hops to off-channel 2 for 50 milliseconds, e.g., to receive communications from a legacy client. The AP MLD then hops back to the home channel, and after 50 milliseconds, hops to channel 4. After 50 milliseconds, the AP MLD hops back to the home channel 10 and operates on that channel for 3,000 milliseconds.

The 50 milliseconds for which the AP MLD is associated with channel 2 may be referred to as a “dwell time.” Similarly, the AP MLD has a 50 milliseconds dwell time on channel 4. During these dwell times, the downlink traffic to the associated STA is paused and the AP MLD may not acknowledge any uplink traffic from the associated STA. Service to the STAs associated with the AP MLD may therefore be impacted. Where an STA has an SLA associated therewith, the SLA may be breached.

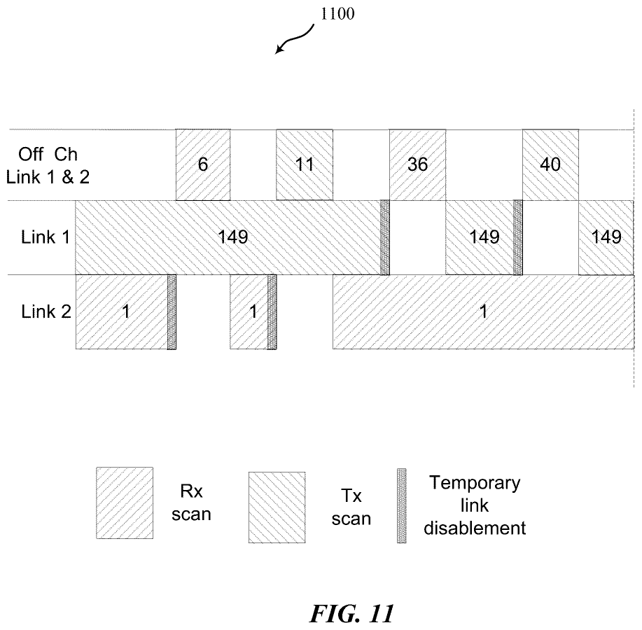

FIG. 11 shows a schematic 1100 illustrating the use of TID-to-link mapping in association with off-channel scanning, according to some aspects. In this example, the AP MLD is operating on link 1 (5 GHZ) and link 2 (2.4 GHz). As shown in FIG. 11, in cases in which the AP MLD identifies an event associated with the unavailability of a link, e.g., identifies an upcoming off-channel scan, the AP MLD may temporarily disable that link using TID-to-link signaling. For example, Link 2 (the 2.4 GHz link) may be temporarily disabled when the AP hops to channel 6 or channel 11 from home channel 1 for a dwell period. Similarly, Link 1 (the 5 GHz link) may be temporarily disabled when the AP hops to channel 36 or channel 40 from home channel 149 for a dwell period. The STAs and AP may continue to operate on the other link at least until the off-channel activity is completed. In this way, breach of SLAs associated with the STAs may be avoided.

Automatic Channel Selection (ACS) is another event that may be associated with the unavailability of a link. ACS is a mechanism via which an AP selects an operating channel that minimizes interference (e.g., with other APs and from non-Wi Fi sources). The interference may be Additive white Gaussian noise (AWGN), continuous-wave or heavy Wi-Fi interference, or other disturbance. An AP MLD may periodically (e.g., every hour, 12 hours, 24 hours, et cetera) scan the environment to locate a channel for optimizing or improving performance. Such a scan may impact service to STA MLDs associated with the AP MLD, including those having an SLA associated therewith. In an aspect, the AP MLD may employ TID-to-link mapping to allow the AP MLD to communicate with the STAs on another link while the periodic or other ACS scans are being conducted. Upcoming breaches of SLAs associated with STAs may therefore be avoided.

The techniques described herein may also be usable to avoid potential upcoming breaches of SLAs associated with ACS due to Automatic Frequency Coordination (AFC). AFC is a is a spectrum use coordination system that consists of a registered database of all the bands in use by various types of radio frequency services in a particular area. It is used by Wi-Fi access points (APs), especially those that operate in the newly allocated 6 GHz band (5.925-7.125 GHz), because the 6 GHz was already in use by services such as fixed satellite service (FSS) used in the broadcast and cable industries. ACS imposes restrictions on the use of the 6 GHz band to ensure unlicensed users do not impact current services.

In brief, the FCC defines two types of device classifications with the goal to avoid potential interference with existing 6 GHz devices: lower power APs for indoor Wi-Fi and standard power APs for indoor/outdoor Wi-Fi. The low power APs have reduced power levels since they are only used indoors, and as such, they are unlikely to interfere with existing 6 GHZ users. The outdoor or standard power APs have a higher chance of interfering with existing 6 GHz users in the area. The AFC system devised by the FCC is configured to ensure these standard power APs do not impact the current services. Under AFC, any new AP may be required consult a registered database to confirm that its operation will not impact a registered user. Specifically, an AFC provider may contain a database of existing 6 GHz operators, including geolocation, frequencies, power levels, antenna coverage, etc. Before transmission, a standard power AP may be required to consult the AFC provider. The AFC provider may approve the usage request or provide alternatives (e.g., alternative channels). Only then may the AP operate in the 6 GHz band.

The response from the AFC provider may be valid only for a limited duration, and as such, the AP may be required to obtain updated responses form the AFC provider from time to time. The response from the AFC may indicate that the AP may no longer use the channel (e.g., the current channel may not be capable of supporting standard power, another channel may be better suited for the AP, et cetera). An AP may employ TID-to-link mapping signaling and the techniques described herein to steer the AP MLD and STAs to a link other than the link associated with the ACS, and consequently, proactively avoid breach of an SLA associated with an STA.

Advertisement of a Quiet information element is yet another example of an event associated with an upcoming SLA breach for an SLA-aware device operating on a link. The Quiet information element may define an interval during which, with limited exceptions, no transmission from the STAs occurs in the current channel. In an aspect, an AP MLD may transmit a TID-to-link mapping scheme in association with a Quiet information element to enable the STAs to communicate with the AP MLD on a different link unaffected by the Quiet element. The SLA-aware STAs may continue to communicate with the AP MLD while a duration of the Quiet information element is enforced on a different channel of a different link, thereby avoiding breach of an SLA associated with an STA.

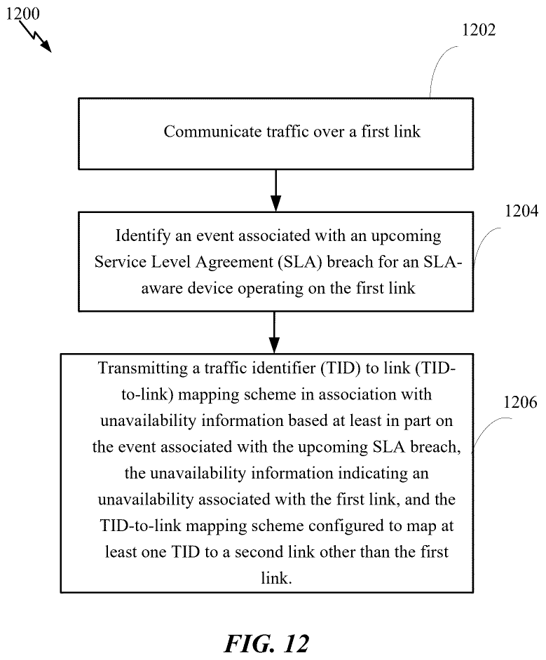

FIG. 12 shows a flowchart illustrating an example process 1200 performable by an AP MLD that supports TID-to-link mapping, according to some aspects. The AP MLD may be, for example, AP MLD 102 discussed above with reference to FIG. 1, or another AP MLD.

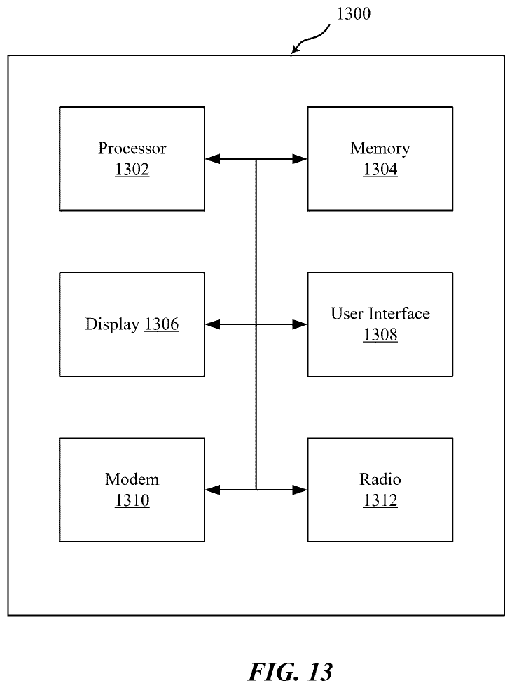

The operations of the process 1200 may be implemented by a wireless AP or its components as described herein. For example, the process 1200 may be performed by a wireless communication device, such as the wireless communication device 1300 described with reference to FIG. 13, operating as or within a wireless AP. In some examples, the process 1200 may be performed by an AP MLD such as the AP MLD 102 described with reference to FIG. 1.

At block 1202, the AP MLD may communicate traffic over a first link. In some examples, the AP MLD may map all TIDS to the first link using global TID-to-link mapping. In some examples, the AP MLD may map TIDs associated with a particular STA to the first link employing peer-to-peer TID-to-link mapping.

At block 1204, the AP MLD may identify an event associated with an upcoming service-level agreement (SLA) breach for an SLA-aware device operating on the first link. As discussed herein, the event may be any event associated with an upcoming SLA breach for an SLA-aware device operating on the first link. In aspects, the event may be associated with the detection of radio on the first link (e.g., the event may be associated with a Channel Switch Announcement, a Channel Availability Check, a channel calibration procedure, et cetera). The event may be associated with Automatic Channel Selection (ACS) (e.g., the event may be associated with ACS associated with interference, Automatic Frequency Coordination (AFC), et cetera). The event may be associated with off-channel scanning. Or the event may be another event associated with an upcoming SLA breach of an SLA-aware device operating on the first link.

At block 1206, the AP may transmit a traffic identifier (TID) to link (TID-to-link) mapping scheme in association with unavailability information based at least in part on the event associated with the upcoming SLA breach. The unavailability information may indicate an unavailability associated with the first link, and the TID-to-link mapping scheme may be configured to map at least one TID to a second link other than the first link.

FIG. 13 shows a block diagram of an example wireless communication device 1300 that supports TID-to-link mapping, according to some aspects of the present disclosure. In some examples, the wireless communication device 1300 is configured or operable to perform all or part of the process 1200 described with reference to FIG. 12. In various examples, the wireless communication device 1300 can be a chip, SoC, chipset, package or device that may include: one or more modems (such as a Wi-Fi modem or a cellular modem such as 3 4G LTE or 5G compliant modem); one or more processors, processing blocks or processing elements (collectively “the processor” 1302); one or more radios (collectively “the radio” 1312); and one or more memories or memory blocks (collectively “the memory” 1304).

The wireless communication device 1300 includes a processor component 1302, a memory component 1304, and display component 1306, a user interface component 1308, a modem component 1310, and a radio component 1312. Portions of one or more of the components 1306, 1308, 1310, and 1312 may be implemented at least in part in hardware or firmware. In some examples, at least some of the components 1306, 1308, 1310, and 1312 of the device 1300 are implemented at least in part by a processor and as software stored in a memory. For example, portions of one or more of the display component 1306, the user interface component 1308, and the modem component 1310 can be implemented as non-transitory instructions (or “code”) executable by the processor 1302 to perform the functions or operations of the respective module.

In some implementations, the processor 1302 may be a component of a processing system. A processing system may generally refer to a system or series of machines or components that receives inputs and processes the inputs to produce a set of outputs (which may be passed to other systems or components of, for example, the device 1300). For example, a processing system of the device 1300 may refer to a system including the various other components or subcomponents of the device 1300, such as the processor, or a transceiver, or a communications manager, or other components or combinations of components of the device 1300. The processing system of the device 1300 may interface with other components of the device 1300 and may process information received from other components (such as inputs or signals) or output information to other components. For example, a chip or modem of the device 1300 may include a processing system, a first interface to output information and a second interface to obtain information. In some implementations, the first interface may refer to an interface between the processing system of the chip or modem and a transmitter, such that the device 1300 may transmit information output from the chip or modem. In some implementations, the second interface may refer to an interface between the processing system of the chip or modem and a receiver, such that the device 1300 may obtain information or signal inputs, and the information may be passed to the processing system. A person having ordinary skill in the art will readily recognize that the first interface also may obtain information or signal inputs, and the second interface also may output information or signal outputs.

The processor 1302 is capable of, configured to, or operable to processes information received through the radio 1312 and the modem 1310, and processes information to be output through the modem 1310 and the radio 1312 for transmission through the wireless medium. The processor 1302 may perform logical and arithmetic operations using program instructions stored within the memory 1304. The instructions in the memory 1304 may be executable (by the processor 1302, for example) to implement the methods described herein. In some examples, the processor 1302, together with the memory 1304, are capable of, configured to, or operable to: communicate traffic over a first link; identify an event associated with an upcoming service-level agreement (SLA) breach for a SLA-aware device operating on the first link; and transmit a traffic identifier (TID) to link (TID-to-link) mapping scheme in association with unavailability information based at least in part on the event associated with the upcoming SLA breach, where the unavailability information indicates an unavailability associated with the first link, and where the TID-to-link mapping scheme is configured to map at least one TID to a second link other than the first link.

The memory 1304 is capable of, configured to, or operable to store and communicate instructions and data to and from the processor 1302.

The user interface 1308 may be any device that allows a user to interact with the wireless communication device 1300, such as a keyboard, a mouse, a microphone, et cetera. In aspects, the user interface 1308 may be integrated with the display component 1306 to present a touchscreen.

The modem 1310 is capable of, configured to, or operable to modulate packets and to output the modulated packets to the radio 1312 for transmission over the wireless medium. The modem 1310 is similarly configured to obtain modulated packets received by the radio 1312 and to demodulate the packets to provide demodulated packets.

The radio 1312 includes at least one radio frequency transmitter and at least one radio frequency receiver, which may be combined into one or more transceivers. The transmitter(s) and receiver(s) may be coupled to one or more antennas. In some aspects, the processor 1302, the memory 1304, the modem 1310, and the radio 1312 may collectively facilitate the wireless communication of the wireless communication device 1300 with other wireless communication devices over multiple frequency bands (such as 2.4 GHz, 5 GHz, or 6 GHz).

In some examples, the wireless communication device 1300 can be a device for use in an AP, such as one of AP MLD 102, 302, 402, 602, 702, or 902 described respectively with reference to FIGS. 1, 3, 4, 6, 7, and 9, or another suitable AP MLD. In some other examples, the wireless communication device 1300 can be an AP that includes such a chip, SoC, chipset, package or device as well as multiple antennas. The wireless communication device 1300 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE family of wireless communication protocol standards. In some examples, the wireless communication device 1300 also includes or can be coupled with an application processor which may be further coupled with another memory. In some examples, the wireless communication device 1300 further includes at least one external network interface that enables communication with a core network or backhaul network to gain access to external networks including the Internet.

In some examples, the wireless communication device 1300 can be a device for use in a STA, such one of STA MLD 104, 304, 404, 604, 704, 904 described respectively with reference to FIGS. 1, 3, 4, 6, 7, and 9, or another suitable STA MLD. In some other examples, the wireless communication device 1300 can be a STA that includes such a chip, SoC, chipset, package, or device as well as multiple antennas. The wireless communication device 1300 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 1302.13 family of wireless communication protocol standards. In some examples, the wireless communication device 1300 also includes or can be coupled with an application processor which may be further coupled with another memory. In some examples, the wireless communication device 1300 further includes a user interface (UI) (such as a touchscreen or keypad) and a display, which may be integrated with the UI to form a touchscreen display. In some examples, the wireless communication device 1300 may further include one or more sensors such as, for example, one or more inertial sensors, accelerometers, temperature sensors, pressure sensors, or altitude sensors.

Implementation examples are described in the following numbered clauses:
1. A method for wireless communication performable at a wireless access point (AP) multi-link device (MLD), including:
communicating traffic over a first link;
identifying an event associated with an upcoming service-level agreement (SLA) breach for an SLA-aware device operating on the first link; and
transmitting a traffic identifier (TID) to link (TID-to-link) mapping scheme in association with unavailability information based at least in part on the event associated with the upcoming SLA breach, the unavailability information indicating an unavailability associated with the first link, and the TID-to-link mapping scheme configured to map at least one TID to a second link other than the first link.
2. The method of clause 1, where the unavailability information indicates an unavailability start time and an unavailability duration.
3. The method of any of clauses 1 or 2, where the event is associated with causing the upcoming SLA breach.
4. The method of any of clauses 1, 2 or 3, where the TID-to-link mapping scheme is configured to map all TIDs to the second link.
5. The method of any of clauses 1, 2, 3, or 4, where the TID-to-link mapping scheme is configured to map a subset of all TIDs to the second link.
6. The method of any of clauses 1, 2, 3, 4, or 5, where: the unavailability information indicates an unavailability duration; and the TID-to-link mapping scheme is configured to map all TIDs to the second link for at least the unavailability duration.
7. The method of any of clauses 1, 2, 3, 4, 5, or 6, where: the first link is a 5 GHz link; a Dynamic Frequency Selection (DFS) channel is a home channel; and the event is associated with detecting radar on the home channel.
8. The method of any of clauses 1, 2, 3, 4, 5, 6, or 7, where an unavailability duration of the 5 GHz link is associated with a channel availability check time.
9. The method of any of clauses 1, 2, 3, 4, 5, 6, 7, or 8, where the event is associated with off-channel activity.
10. The method of any of clauses 1, 2, 3, 4, 5, 6, 7, 8, or 9, where the event is associated with an Automatic Channel Selection (ACS) scan.
11. The method of any of clauses 1, 2, 3, 4, 5, 6, 7, 8, 9, or 10, where:
the first link is a 6 GHz link; and
the event is associated with automatic frequency coordination (AFC).
12. The method of any of clauses 1, 2, 3, 4, 5, 6, 7, 8, 9, 10, or 11, where transmitting the TID-to-link mapping scheme includes advertising two TID-to-link mapping information elements in a beacon frame.
13. The method of any of clauses 1, 2, 3, 4, 5, 6, 7, 8, 9, 10, 11, or 12, further including determining that the event is associated with the upcoming SLA breach for the SLA-aware device operating on the first link.
14. An access point (AP), including:
at least one memory; and
at least one processor communicatively coupled with the at least one memory and operable to cause the AP to:
   communicate traffic over a first link;
   identify an event associated with an upcoming service-level agreement (SLA) breach for an SLA-aware device operating on the first link; and
   transmit a traffic identifier (TID) to link (TID-to-link) mapping scheme in association with unavailability information based at least in part on the event associated with the upcoming SLA breach, the unavailability information indicating an unavailability associated with the first link, and the TID-to-link mapping scheme configured to map at least one TID to a second link other than the first link.
15. The AP of clause 14, where the unavailability information indicates an unavailability start time and an unavailability duration.
16. The AP of any of clauses 14 or 15, where the event is associated with causing the upcoming SLA breach.
17. The AP of any of clauses 14, 15 or 16, where the TID-to-link mapping scheme is configured to map all TIDs to the second link.
18. The AP of any of clauses 14, 15, 16, or 17, where the TID-to-link mapping scheme is configured to map a subset of all TIDs to the second link.
19. The AP of any of clauses 14, 15, 16, 17, or 18, where:
the unavailability information indicates an unavailability duration; and
the TID-to-link mapping scheme is configured to map all TIDs to the second link for at least the unavailability duration.
20. The AP of any of clauses 14, 15, 16, 17, 18, or 19, where:
the first link is a 5 GHz link;
a Dynamic Frequency Selection (DFS) channel is a home channel; and
the event is associated with detecting radar on the home channel.
21. The AP of any of clauses 14, 15, 16, 17, 18, 19, or 20, where an unavailability duration of the 5 GHz link is associated with a channel availability check time.

22. The AP of any of clauses 14, 15, 16, 17, 18, 19, 20, or 21, where the event is associated with off-channel activity.
23. The AP of any of clauses 14, 15, 16, 17, 18, 19, 20, 21, or 22, where the event is associated with an Automatic Channel Selection (ACS) scan.
24. The AP of any of clauses 14, 15, 16 17, 18, 19, 20, 21, 22, or 23, where:
the first link is a 6 GHz link; and
the event is associated with automatic frequency coordination (AFC).
25. The AP of any of clauses 14, 15, 16, 17, 18, 19, 20, 21, 22, 23, or 24, where transmitting the TID-to-link mapping scheme includes advertising two TID-to-link mapping information elements in a beacon frame.
26. The AP of any of clauses 14, 15, 16, 17, 18, 19, 20, 21, 22, 23, 24, or 25, where the processor is further operable to determine that the event is associated with the upcoming SLA breach for the SLA-aware device operating on the first link.
27. A method for wireless communication performable at a wireless access point (AP) multi-link device (MLD), including:
transmitting a first traffic identifier (TID) to link (TID-to-link) mapping scheme to map at least one TID to the first link;
communicating traffic over the first link;
identifying an event associated with an upcoming service-level agreement (SLA) breach for an SLA-aware device operating on the first link; and
transmitting a second traffic identifier (TID) to link (TID-to-link) mapping scheme in association with unavailability information based at least in part on the event associated with the upcoming SLA breach, the unavailability information indicating an unavailability associated with the first link, and the second TID-to-link mapping scheme configured to map at least one TID to a second link other than the first link.
28. The method of clause 27, where the first TID-to-link mapping scheme is advertised in a beacon frame.
29. The method of any of clauses 27 or 28, where the first TID-to-link mapping scheme is a peer-to-peer TID-to-link mapping scheme.
30. The method of any of clauses 27, 28, or 29, where the event is selected from a group consisting of radar detection, an Automatic Channel Scan (ACS), and Automatic Frequency Coordination (AFC).

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A method for wireless communication performable at a wireless access point (AP) multi-link device (MLD), comprising:
communicating traffic over a first link;
identifying an event associated with an upcoming service-level agreement (SLA) breach for an SLA-aware device operating on the first link; and
transmitting a traffic identifier (TID) to link (TID-to-link) mapping scheme in association with unavailability information based at least in part on the event associated with the upcoming SLA breach, the unavailability information indicating an unavailability associated with the first link, and the TID-to-link mapping scheme configured to map at least one TID to a second link other than the first link.

2. The method of claim 1, wherein the unavailability information indicates an unavailability start time and an unavailability duration.

3. The method of claim 1, wherein the event is associated with causing the upcoming SLA breach.

4-13. (canceled)

14. An access point (AP), comprising:
at least one memory; and
at least one processor communicatively coupled with the at least one memory and operable to cause the AP to:
communicate traffic over a first link;
identify an event associated with an upcoming service-level agreement (SLA) breach for an SLA-aware device operating on the first link; and
transmit a traffic identifier (TID) to link (TID-to-link) mapping scheme in association with unavailability information based at least in part on the event associated with the upcoming SLA breach, the unavailability information indicating an unavailability associated with the first link, and the TID-to-link mapping scheme configured to map at least one TID to a second link other than the first link.

15. The AP of claim 14, wherein the unavailability information indicates an unavailability start time and an unavailability duration.

16. The AP of claim 14, wherein the event is associated with causing the upcoming SLA breach.

17. The AP of claim 14, wherein the TID-to-link mapping scheme is configured to map all TIDs to the second link.

18. The AP of claim 14, wherein the TID-to-link mapping scheme is configured to map a subset of all TIDs to the second link.

19. The AP of claim 14, wherein:
the unavailability information indicates an unavailability duration; and
the TID-to-link mapping scheme is configured to map all TIDs to the second link for at least the unavailability duration.

20. The AP of claim 14, wherein:
the first link is a 5 GHz link;
a Dynamic Frequency Selection (DFS) channel is a home channel; and
the event is associated with detecting radar on the home channel.

21. The AP of claim 14, wherein an unavailability duration of the 5 GHz link is associated with a channel availability check time.

22. The AP of claim 14, wherein the event is associated with off-channel activity.

23. The AP of claim 14, wherein the event is associated with an Automatic Channel Selection (ACS) scan.

24. The AP of claim 14, wherein:
the first link is a 6 GHz link; and
the event is associated with automatic frequency coordination (AFC).

25. The AP of claim 14, wherein transmitting the TID-to-link mapping scheme includes advertising two TID-to-link mapping information elements in a beacon frame.

26. The AP of claim 14, wherein the processor is further operable to determine that the event is associated with the upcoming SLA breach for the SLA-aware device operating on the first link.

27. A method for wireless communication performable at a wireless access point (AP) multi-link device (MLD), comprising:
transmitting a first traffic identifier (TID) to link (TID-to-link) mapping scheme to map at least one TID to the first link;
communicating traffic over the first link;
identifying an event associated with an upcoming service-level agreement (SLA) breach for an SLA-aware device operating on the first link; and
transmitting a second traffic identifier (TID) to link (TID-to-link) mapping scheme in association with unavailability information based at least in part on the event associated with the upcoming SLA breach, the unavailability information indicating an unavailability associated with the first link, and the second TID-to-link mapping scheme configured to map at least one TID to a second link other than the first link.

28. The method of claim 27, wherein the first TID-to-link mapping scheme is advertised in a beacon frame.

29. The method of claim 27, wherein the first TID-to-link mapping scheme is a peer-to-peer TID-to-link mapping scheme.

30. The method of claim 27, wherein the event is selected from a group consisting of radar detection, an Automatic Channel Scan (ACS), and Automatic Frequency Coordination (AFC).
